(19) United States
(12) Patent Application Publication
(10) Pub. No.: US 2013/0100174 A1
(43) Pub. Date: Apr. 25, 2013

(54) Luminaire

(71) Applicants: Hirokazu Yamada, Yokosuka-shi (JP); Jun Matsumoto, Yokosuka-shi (JP)

(72) Inventors: Hirokazu Yamada, Yokosuka-shi (JP); Jun Matsumoto, Yokosuka-shi (JP)

(73) Assignee: TOSHIBA LIGHTING & TECHNOLOGY CORPORATION, Yokosuka-shi (JP)

(21) Appl. No.: 13/608,235

(22) Filed: Sep. 10, 2012

(30) Foreign Application Priority Data
Oct. 25, 2011 (JP) 2011-233912

(51) Int. Cl. G09G 5/10

(52) U.S. Cl. 345/690

(57) ABSTRACT

According to one embodiment, a luminaire includes an image forming part, a display part, a light-emitting part and a control part. The image forming part is configured to form an image. The display part is configured to display the image formed. by the image forming part. The light-emitting part is configured to generate a light having directivity, and to irradiate the light through the display part to an irradiation area, with luminous intensity distribution of the light being controlled. The control part is configured to control the image forming part, the display part and the light-emitting part.

### CROSS-REFERENCE TO RELATED APPLICATION

This application is based upon and claims the benefit of priority from Japanese Patent Application No. 2011-233912 filed on Oct. 25, 2011, the entire contents of which are incorporated herein. by reference.

### FIELD

Embodiments described herein relate generally to a luminaire in which an image and irradiation of light having directivity are combined.

### BACKGROUND

Hitherto, a luminaire is proposed which provides an illumination environment in harmony with a biological rhythm such as a circadian rhythm.

This kind of luminaire provides the illumination environment in harmony with the circadian rhythm by adjusting the color temperature of illumination during daytime and at night. However, the characteristic of light that changes in a natural environment is not only the color temperature. For example, the brightness ratio (contrast of light) in a room changes. Besides, for example, the color temperature of light coming through a window changes with the lapse of time in a day, and the direction (directivity) of the incoming light also sequentially changes. Further, a shadow may be formed by a blind or the like.

Thus, in the luminaire providing the illumination environment in harmony with the biological rhythm such as the circadian rhythm, it is desirable that an illumination environment closer to a natural environment be provided.

### DESCRIPTION OF THE DRAWINGS

FIG. 1A is a perspective view of a luminaire of a first embodiment;

FIG. 1B is a perspective view of a light-emitting part of the first embodiment;

FIG. 2 is a block diagram of the luminaire of the first embodiment;

FIG. 3 is a perspective view showing a state in which the luminaire of the first embodiment is installed in a room to generate a state where the morning sunlight comes in;

FIG. 4 is a perspective view showing a state in which the luminaire of the first embodiment is installed in a room to generate a state where the daylight comes in;

FIG. 5 is a perspective view showing an illumination system using the luminaire of the first embodiment;

FIG. 6 is a perspective view of a luminaire of a second embodiment;

FIG. 7 is a block diagram of the luminaire of the second embodiment;

FIG. 8 is a perspective view showing a state where the luminaire of the second embodiment is installed in a room;

FIG. 9 is a block diagram of a luminaire of a third embodiment;

FIG. 10 is a perspective view showing the luminaire and an illumination system of the third embodiment; and

FIG. 11 is a block diagram of an illumination system of a modified example.

### DETAILED DESCRIPTION

In general, according to one embodiment, a luminaire includes an image forming part, a display part, a light-emitting part and a control part. The image forming part is configured to form an image. The display part is configured to display the image formed by the image forming part. The light-emitting part is configured to generate a light having directivity, and to irradiate the light through the display part to an irradiation area with luminous intensity distribution of the light being controlled. The control part is configured to control the image forming part, the display part and the light-emitting part

Hereinafter, luminaires of embodiments will be described with reference to the drawings. In the respective embodiments, the same part is denoted by the same reference numeral and the duplicate description thereof will be omitted.

### First Embodiment

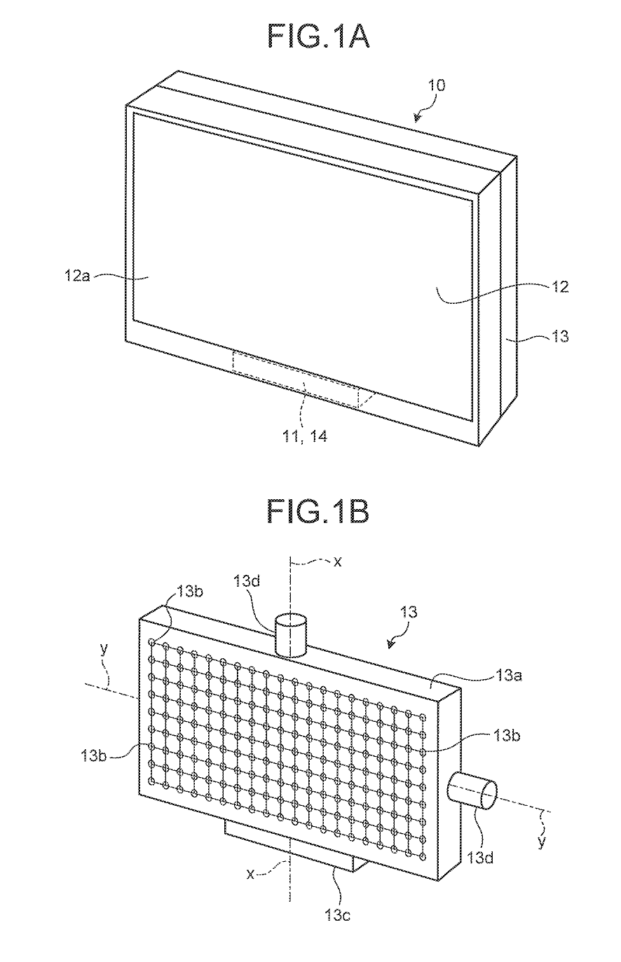

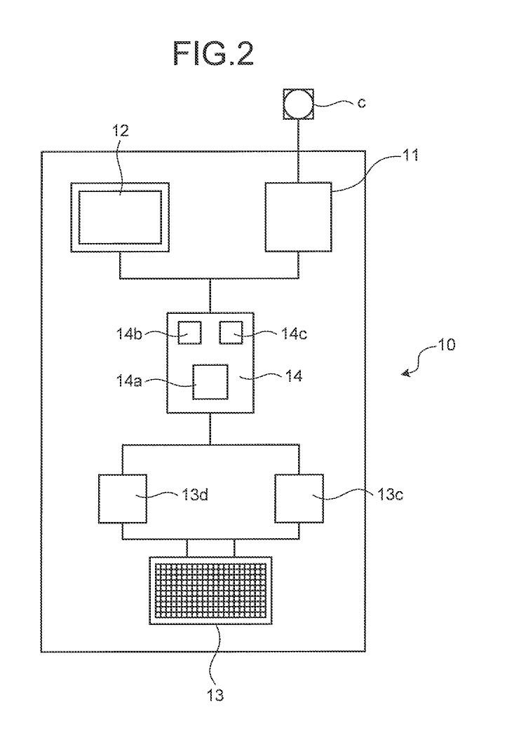

A luminaire of a first embodiment provides, for example, an illumination environment in harmony with a biological rhythm. As illustrated in FIG. 1A, FIG. 13 and FIG. 2, a luminaire 10 includes an image forming part 11 that forms an image, a display part 12 that displays the image formed by the image forming part 11, a light-emitting part 13 that generates and irradiates light having directivity, and a control part 14 that controls the image forming part 11, the display part 12 and the light-emitting part 13.

The image forming part 11 forms an image based on light. irradiation in a natural environment. For example, the image forming part 11 forms an image of a sky which continuously changes during a day. In the image forming part 11, the images of a sky continuously changing in a day and previously taken. by a camera “c” (see FIG. 2) are stored in a memory 14b (see FIG. 2, described later), and the image is formed by calling up the stored image. Alternatively, the image may be formed by taking the actual sky image of the day by the camera “c”.

The image formed by the image forming part 11 is desirably the image of the sky continuously changing from dawn to sunset during a day. However, the image forming part 11 may be configured such that a day is divided in units of several hours, and simple images, such as an image of the morning sunlight, an image of a blue sky during the daytime, an image of the evening sun, an image of a sunset and an image after the sunset, may be formed for the respective periods.

Besides, the image forming part 11 may be configured such that an image not corresponding to a time axis, for example, an image of one's choice such as an underwater image or an image of the universe is formed. In this case, the after-mentioned light-emitting part 13 provides streaming light corresponding to the image. In brief, as long as the light and shadow, and the orientation of light based on the image can be generated, the structure and means of the image forming part 11 are not limited.

The display part 12 is a panel-shaped display device having a shape and a size corresponding to a window of a room of a building. In the first embodiment, the display part 12 is a liquid crystal display device including a liquid crystal panel 12a. The display part 12 displays an image formed by the image forming part 11, so that the continuously changing state of the sky is seen through the pseudo window of the room. The display part 12 may be a cathode-ray tube or a small electronic display plate including many light sources such as light-emitting diodes.

The light-emitting part 13 generates a large amount of light having directivity. The light-emitting part 13 is a light-emitting device in which a light source is, for example, a light-emitting diode (hereinafter referred to as LED) having a relatively high light directivity and high brightness and high output. The light-emitting part 13 is incorporated as a backlight of the liquid crystal display device constituting the display part 12, and irradiates the light which passes through the liquid crystal display device to an irradiation area in such a manner that luminous intensity distribution of the light can be controlled.

FIG. 1B depicts one example of the light-emitting part 13 configured as a backlight. The light-emitting part 13 includes a board 13a, plural white LEDs 13b, a lighting part 13c and a driving part 13d. The board 13a has substantially the same shape as the liquid crystal display device. The plural white LEDs 13b are arranged substantially in a matrix form on one surface side of the board 13a. The plural white LEDs 13b include LEDs different in color temperature, such as daylight color, neutral white color or warm white color. The lighting part 13c controls and lights the LEDs different in color temperature, and generates a light corresponding to natural light color continuously changing from dawn to sunset during a day and having directivity. The light generated by the light-emitting part 13 and having the light color and the directivity is emitted from the one surface side of the board 13a to the back surface side of the liquid crystal display device, and the light passing through the sky image displayed on the liquid crystal panel 12a is irradiated to the irradiation area while the luminous intensity distribution of the outgoing light is controlled.

That is, the board 13a constituting the light-emitting part 13 is configured to be capable of being rotated by the driving part 13d constructed. of a micro motor or the like a specific angle around a vertical axis x-x and a horizontal axis y-y, and the direction of the light emitted to the outside through the liquid crystal panel 12a can be changed. The driving part 13d rotates the board 13a in the up-and-down direction (rotation, around the horizontal axis y-y), and rotates the board 13a in the right-and-left, direction (rotation around the vertical axis x-x). By this, the direction of the light passing through the liquid crystal panel 12a can be continuously set to any direction achievable through the combination of the up-and-down direction and the left-and-right direction, and the outgoing light passing through the liquid crystal panel 12a can be irradiated to the irradiation area, that is, the inside of the room in such a manner that the luminous intensity distribution can be controlled.

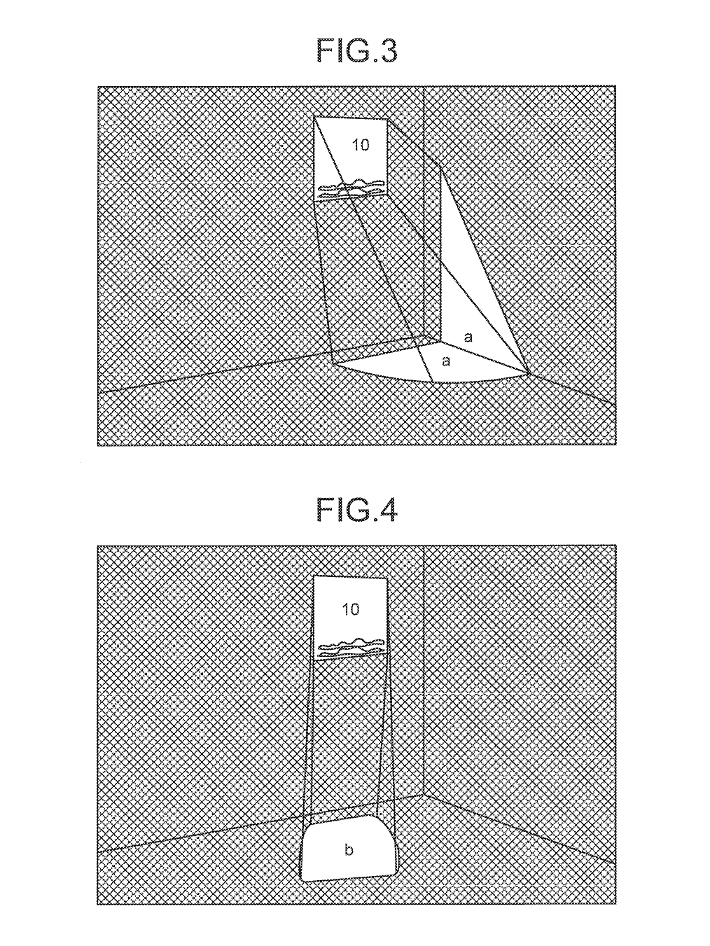

By this, as shown in FIG. 3 and FIG. 4, the sun light tilted according to the change of height of the sun in a day can be formed; that is, a light “a” (seen. when the morning sunlight comes into the room: FIG. 3) coming through a. window in a diagonally downward direction from an upper left portion to a lower right portion of the room, and a light “b” (seen when the daytime light comes into the room: FIG. 4) coming through the window in a diagonally downward direction from an upper portion to a lower portion of the room can be respectively formed. These lights have directivity, and the incoming direction sequentially changes with the lapse of time during a day.

Thus, artificial light can be irradiated into the room through the image of a sky displayed on the liquid crystal panel 12a so as to create a state where one can feel as if the natural sunlight is coming into the room through the window. Incidentally, if a liquid crystal having a relatively high light transmittance is used as the liquid crystal panel 12a, a large amount of light having higher directivity can be emitted from the liquid crystal display device through the image.

As shown in FIG, 2, the control part 14 controls the image forming part 11, the display part 12 and the light-emitting part 13. The control part 14 includes a control part 14a such as a microcomputer, the memory 14b and a timer 14c which generates a time element. The control part 14a calls up the sky image, which is stored in the memory 14b and continuously changes from dawn to sunset in a day, in accordance with the lapse of time in a day based on the time element generated by the timer 14c, transmits the image to the display part 12 and causes the image to be displayed. By this, the luminaire 10 can perform image display so that the state of the outside sky changing with the lapse of time during a day is irradiated and is seen through the pseudo window of the room.

The control part 14 synchronizes with the above image display operation, and controls the light-emitting part 13 in accordance with the lapse of time in a day based on the time element generated by the timer 14c. That is, the control part 14 transmits a control signal to the lighting part 13c, controls and lights the plural white LEDs different in color temperature, and continuously changes the LEDs so that the light color changing with the lapse of time can be emitted. Besides, the control part 14 transmits the control signal to the driving part 13d of the light-emitting part 13 in synchronization with the image display operation and the change operation of the light color, and controls the board 13a so that the board is rotated in the up-and-down and the right-and-left directions. That is, the control part 14 continuously changes the light emitted by the light-emitting part 13 in accordance with the lapse of time, so that the direction of the light coming through the window is changed in accordance with the direction of the light and shadow changing with the change of height of the sun, the moon, stars and the like.

By this, the state of the direction of light in a day, that is, the irradiation state of the light streaming through the window can be realized, and one can see thus-created light in the room. From the above, the image and the light irradiation of the light having directivity are combined. The luminaire 10 with the size of a house window is thus configured.

Incidentally, the memory 14b is configured so that the plural sky images changing with the lapse of time in a day are correlated with time and are stored, and the stored image correlated with the time corresponding to the time element generated by the timer 14c is read from the memory 14b. Alternatively, the memory 14b may store an image which is correlated with a time element corresponding to the image, for example, a time such as 9 a.m. or a time period from 1 p.m. to 3 p.m., and is further correlated with a light irradiation condition corresponding to the time element.

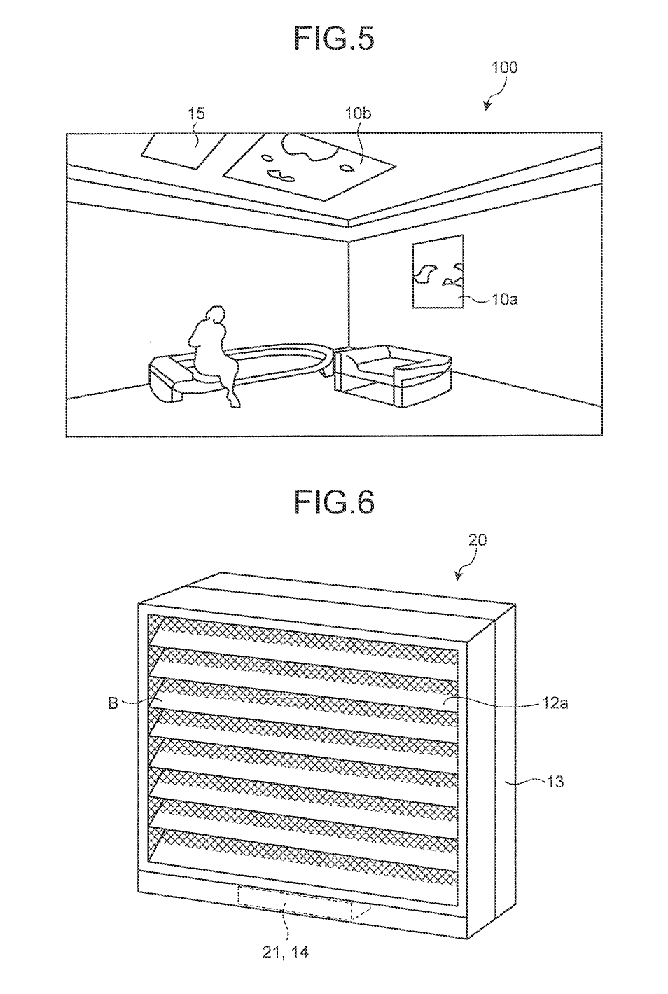

Next, a structure of a luminaire system 100 using the luminaire configured as described above will be described with reference to FIG. 5. As shown in FIG. 5, in the luminaire system 100, one luminaire 10a is installed on a wall surface of a room so that it becomes a pseudo window, and another luminaire 10b is installed on a ceiling so that it becomes a pseudo skylight window. The structure of the luminaire 10a, 10b is the same as that of the luminaire 10.

When the respective luminaires 10a and 10b installed as stated above are lit, the state of the outside sky changing with the lapse of time is irradiated, and the image is displayed so that one can feel as if the outside sky is seen through the respective pseudo windows installed on the wall surface and the ceiling of the room. In synchronization with the image display, the plural white LEDs different in color temperature of the light-emitting part 13 are controlled and lit, and are changed so as to generate a light, color in accordance with the lapse of time. Besides, the driving part 13d of the light-emitting part 13 is driven in synchronization. with the image display operation. and the change operation of the light color, so as to change the direction of the light coming through the respective pseudo windows in accordance with the lapse of time. Thus, one can see, in the room, the irradiation state of the light coming through the windows through the sky image.

After the sunset, the luminaire 10b, which is a pseudo window, installed on the ceiling may emit soft light, together with an image of moon light or light from the night sky, in synchronization with the luminaire 10a on the wall surface. Alternatively, the image may not be displayed on the luminaire 10b on the ceiling, and the luminaire 10b may be used as a simple luminaire such as a ceiling light, or the luminaire 10b may emit light while an image of a luminaire is displayed thereon. Incidentally, the luminaires 10a and 10b installed on the wall. surface and the ceiling, that is, the respective pseudo windows operate in synchronization with each other. Alternatively, a lighting device 15 may be additionally installed on the ceiling, and the lighting device 15 and the luminaires 10a and 10b may be operated in synchronization with each other.

By the above, an arbitrary light can be irradiated at a place and space of one's choice. At the same time, the light having the directivity and a shadow formed thereby can easily create a state close to the natural light, causing a user to feel the lapse of time, seasonal chances, and the like.

Besides, since the depth feeling of the room is created by the light and shadow having the directivity, a sense of closeness can he reduced, and a relaxation effect can be expected. Besides, a scene of one's choice can be reproduced irrespective of the outside weather and the season, and a further relaxation effect can be expected, and the degree of freedom of action can he raised by the relaxation effect.

Further, by the combination and link (synchronization) with the skylight window, the operations and effects can be more effectively obtained. The luminaire and the luminaire system can be provided which can provide the illumination environment closer to the natural environment by combining these effects.

### Second Embodiment

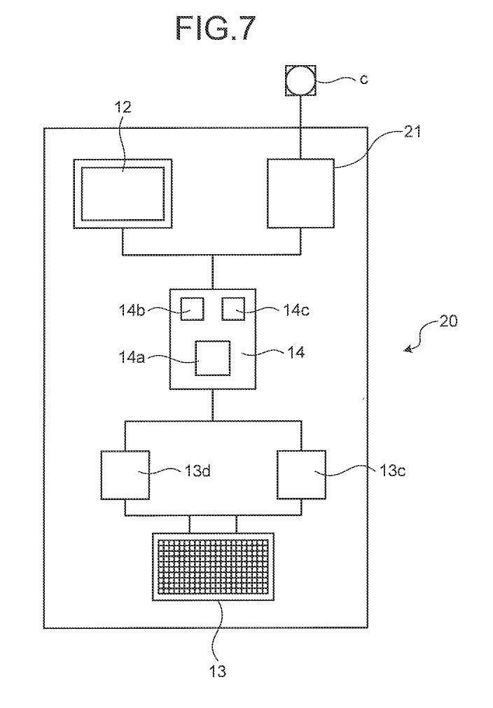

In a second embodiment, a desired luminaire is configured similarly to the first embodiment. In a luminaire 20 of the second embodiment, an image forming part 21 is configured to form one image and another image to block at least a part of the image. Incidentally, as shown in FIG. 7, a structure of the luminaire 20 of the second embodiment except for the image forming part 21 is the same as the first embodiment. Thus, in FIG. 6 to FIG. 8 illustrating the luminaire and a luminaire system of the second embodiment, the same portion as that of the first embodiment is denoted by the same reference numeral and the detailed description thereof will not be repeated.

The image forming part 21 of the luminaire 20 of the second embodiment forms the intensity, color temperature and outgoing angle of light changing with the lapse of time in a day. At the same time, the image forming part 21 forms an image in front of the formed image to block at least a part of the formed image; for example, the image forming part 21 forms an image of a pseudo blind B in the second embodiment (see FIG. 6). The image forming part 21 can form, as the image of the blind B, an image continuously changing from the state where the whole blind is closed to block the light to the state where the blind is opened.

The image changing with the lapse of time in a day formed by the image forming part 21 and the image of the blind B formed on the front surface of the image are displayed on a liquid crystal display device which is the display part 12.

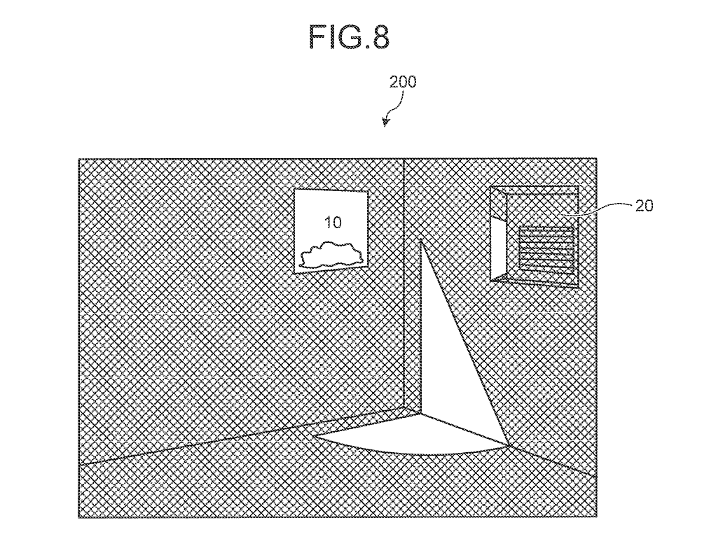

As shown in FIG. 8, the one luminaire 20 constructed as described above is installed on a desired wall surface to form a pseudo window in the same manner as that of the first embodiment, and the luminaire system 200 is constructed. The angle of the displayed blind B is controlled and adjusted, and the angle, the color temperature and the intensity of the light are controlled with the lapse of time, so as to create the light filtering through the blind and the shadow of the blind, which can be seen in a room as if they were natural light and shadow.

Also in the second embodiment, the image blocked by the blind B changes with the lapse of time as in the first embodiment. Besides, plural white LEDs different in color temperature of a light-emitting part 13 are controlled and lit in synchronization with the changes in the image, and are continuously changed to generate light color in accordance with the lapse of time. Besides, a driving part 13d of the light-emitting part 13 is driven in synchronization with the image display operation and the change operation of the light color, and the direction of the light coming through the pseudo window is changed. By this, the state where the light streaming through the window impinges on the back surface of the blind, in other words, the state of the light leaking through the gap of the blind and the shadow can be seen in the room.

According to the second embodiment, the same operation and effect as the first embodiment can be obtained. Further, according to the second embodiment, the window-shaped luminaire can be provided in which the depth feeling of the space can be further obtained by shading and changes in the light amount caused by the blind. Besides, the circadian rhythm is more effectively maintained because one can feel the changes of light more clearly. By these operations and effects, the luminaire and the luminaire system can be provided which can provide the illumination environment closer to the natural environment.

Incidentally, the image to block at least a part of the image formed by the image forming part 21 is not limited to the blind, and the sky image may be partially blocked by, for example, an image of some objects such as branches of trees through which sunbeams stream.

Alternatively, the luminaire 20 with the blind according to the second embodiment may be incorporated in the luminaire system of the first embodiment, and the luminaire system may be configured such that the one luminaire 10a without the blind is installed on the wall surface, the one luminaire 20 with the blind is installed on the wall surface, and the one luminaire 10b without the blind is installed on the ceiling, and the respective luminaires 10a, 10b and 20 installed on the wall surface and the ceiling, that is, the three pseudo windows operate in synchronization with each other.

### Third Embodiment

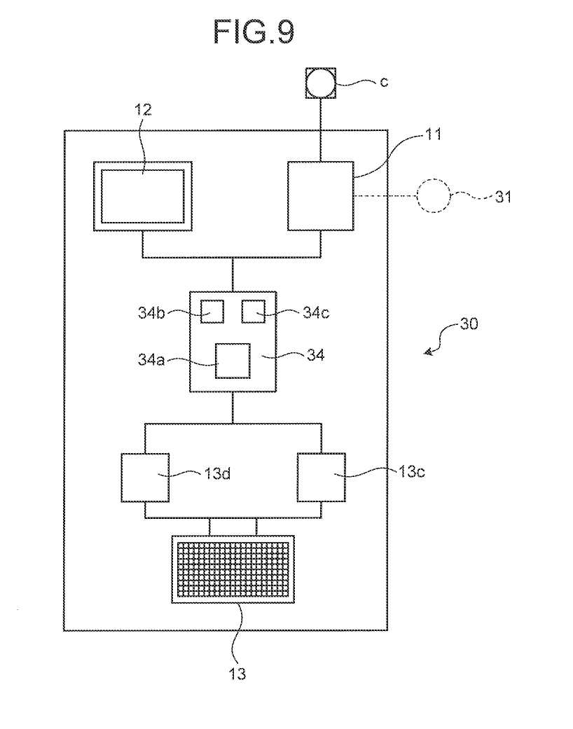

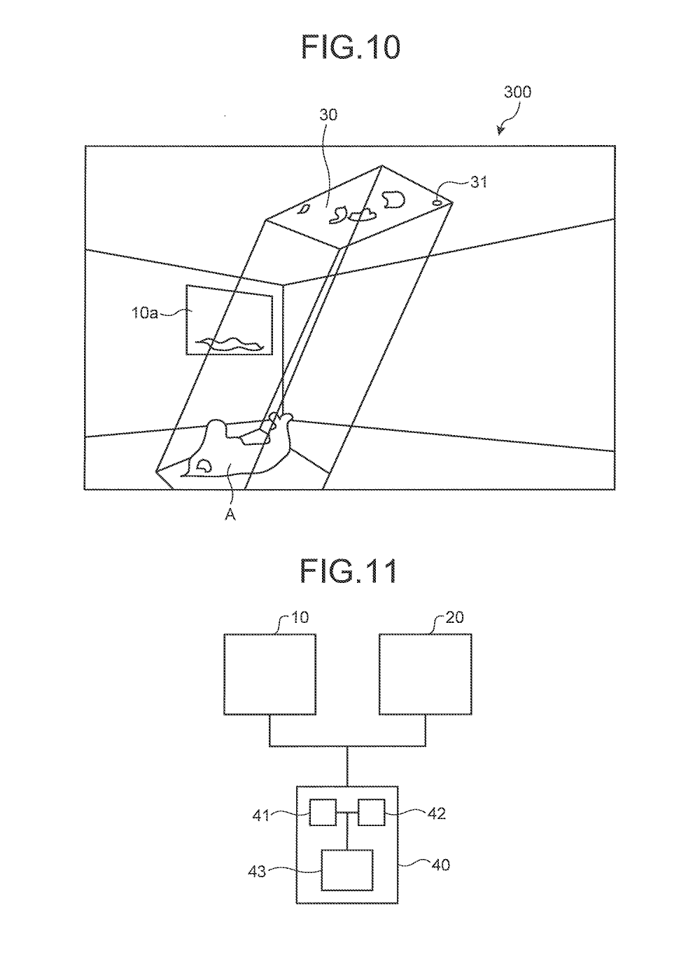

In a third embodiment, a desired luminaire is configured. in the same manner as in the first and the second embodiments. As illustrated in FIG. 9 and FIG. 10, in the third embodiment, a control part 34 is controlled by a human sensing sensor 31. The other structure is the same as the first and the second embodiments. In FIG. 9 and FIG. 10, the same portion as that of the first and the second embodiments is denoted by the same reference numeral and the detailed description thereof will not be repeated.

As illustrated in FIG. 9, the control part 34 of a luminaire 30 of the third embodiment controls the lighting in accordance with the result of sensing by the human sensing sensor 31. As shown in FIG. 10, a luminaire system 300 is configured such that the luminaire 30 with the human sensing sensor 31 is installed on the ceiling of a room and the luminaire 10a without a human sensing sensor is installed on a wall surface to form pseudo windows.

By this, the human sensing sensor 31 senses the existence of a person; for example, the human sensing sensor 31 senses a person “A” lying on the floor, and the luminaire 30 installed on the ceiling irradiates light on the lying person “A” intensively. The lighting state controlled in accordance with the result of sensing by the human sensing sensor 31 changes with the lapse of time in the same manner as in the first and the second embodiments. Besides, in synchronization with this, plural white LEDs different in color temperature of a light-emitting part 13 are controlled and lit, and are continuously changed to generate light color in accordance with the change of the lighting state of the luminaire 30 installed on the ceiling. Besides, a driving part 13d of the light-emitting part 13 is driven in synchronization with the image display operation and the change operation of the light color, and the person lying in the room can see the light whose direction changes with the lapse of time through the pseudo window.

Thus, luxurious lighting space, in which the human sensing sensor senses the movements of each person in the space and the luminaire provides optimal lighting adjusted to the mode of the person based on the result of sensing, can be provided. Besides, free and pleasant space presentation can be realized; for example, a person may relax under the blue sky without feeling the existence of the luminaire, or enjoy an interior representation created by light tapestry.

According to at least one of the embodiments, the luminaire can be provided which can form the illumination environment in which light, together with an image, streams through the display part.

In the respective foregoing embodiments, the control part may control each part to add a weather element; for example, color temperature for fine weather, cloudy weather or rainy weather is set, or the state of intensity of the incoming light is changed. Besides, the control part may control each part to add a seasonal element; for example, color temperature may be set in accordance with the change of seasons, or the intensity and angle of the incoming light may be sequentially changed in accordance with the change of seasons. Further, although an image and light output are changed in accordance with the lapse of time, the control part may control each part to change the light only in synchronization with the changes in the image and not with the time lapse.

The light source of the light-emitting part is preferably formed of an LED chip made of gallium nitride (GaN) semiconductor to emit blue light. However, the light source may be made of a solid light-emitting element including a semiconductor laser or an organic EL (electroluminescence) as a source of luminescence, an incandescent lamp such as a halogen lamp, or a straight tube type fluorescent lamp. Besides, the image may be one taken by a camera and generated, or an image of one's choice may be downloaded and the information thereof may be reproduced.

Besides, for example, when the luminaires of the respective foregoing embodiments are combined to form a luminaire system, an additional control part may be provided in addition to the respective luminaires, and images displayed by the respective luminaires and the light irradiation may be synchronized. For example, in a modified example shown in FIG. 11, a luminaire system includes luminaires 10 and 20 and a control part 40, and the control part 40 is provided with a timer 41, a signal generation part 42 and a transmission part 43. The signal generation part 42 generates control signals to control images and light irradiation realized by the luminaires 10 and 20. The transmission part 43 transmits the generated control signals to the luminaires 10 and 20, and the luminaires 10 and 20 realize desired images and light irradiation. Incidentally, the structures of the luminaires 10 and 20 are the same as those shown in FIG. 2 and FIG. 7. Besides, in this case, the timer may not be provided in each of the luminaires 10 and 20.

Although exemplary embodiments have been described, these embodiments have been presented by way of example only, and are not intended to limit the scope of the invention. Indeed, these novel embodiments can be carried out in a variety of other forms, and various omissions, substitutions and changes can be made within the scope not departing from the gist of the invention. These embodiments and modifications thereof fall within the scope and the gist of the invention and fall within the scope of the invention recited in the claims and their equivalents.

What is claimed is:

1. A luminaire comprising:
an image forming part configured to form an image;
a display part configured to display the image formed by the image forming part;
a light-emitting part configured to generate a light having directivity and irradiates the light through the display part to an irradiation area, luminous intensity distribution of the light being controlled; and
a control part configured to control the image forming part, the display part and the light-emitting part.

2. The luminaire of claim 1, wherein the control part controls the image forming part and the light-emitting part to be synchronized.

3. The luminaire of claim 1, wherein
the display part includes a display panel and a driving part configured to rotate and drive the display panel, and
the driving part rotates and drives the display panel in accordance with a control signal from the control part.

4. The luminaire of claim 1, wherein
the image forming part generates a first image and a second image which blocks the first image, and
the display part displays the first image blocked by the second image.

5. The luminaire of claim 1, further comprising a sensor configured to sense a person, wherein
the control part causes the light-emitting part to irradiate the light intensively to an area where the sensor senses the person.

6. The luminaire of claim 1, wherein the control part controls the image forming part and the light-emitting part to change the image and the light having the directivity in synchronization with a time element.

7. The luminaire of claim 6, further comprising a timer configured to count the time element, wherein
the control part controls the image forming part and the light-emitting part based on the time element counted by the timer.

8. The luminaire of claim 7, further comprising a storage part configured to store a plurality of images corresponding to a plurality of time points or a plurality of time periods in advance, wherein
the control part reads an image corresponding to the time point or the time period corresponding to the time element counted by the timer and causes the display part to display the image.

9. The luminaire of claim 7, further comprising a storage part configured to store a plurality of images continuously taken with lapse of time under a natural environment in advance, wherein
the storage part stores the plurality of images correlated with time elements, and
the control part reads an image corresponding to the time element counted by the timer from the storage part and causes the display part to display the image.

10. The luminaire of claim 9, wherein the storage part stores light irradiation states, which change with the lapse of time under the natural environment, in association with the plurality of images and the time elements, and
the control part reads an image and a light irradiation state corresponding to the time element counted by the timer from the storage part, causes the display part to display the read image, and causes the light-emitting part to irradiate an irradiation light corresponding to the read light irradiation state.

11. An illumination system comprising a first luminaire, a second luminaire and a control device, wherein
each of the first luminaire and the second luminaire includes:
a display part configured to display an image;
a light-emitting part configured to generate a light having directivity and irradiate the light through the display part to an irradiation area, luminous intensity distribution of the light being controlled; and
a control part configured to control the display part and the light-emitting part, and
the control device includes:
a timer configured to count a time element;
a generation part configured to generate control signals for controlling the first and the second luminaires based on the time element counted by the timer; and
a transmission part configured to transmit the control signals to the respective control parts of the first and the second luminaires.
